(19) United States
(12) Patent Application Publication
(10) Pub. No.: US 2008/0191872 A1
(43) Pub. Date: Aug. 14, 2008

(54) METHOD AND APPARATUS FOR SECURING AN ELECTRONIC DEVICE

(76) Inventors: OMAR CARDONA, Austin, TX (US); JAMES BRIAN CUNNINGHAM, Austin, TX (US); BALTAZAR DE LEON, Austin, TX (US)

Correspondence Address: IBM CORP (YA);C/O YEE & ASSOCIATES PC, P.O. BOX 802333, DALLAS, TX, 75380, US

(21) Appl. No.: 11/674,936

(22) Filed: Feb. 14, 2007

(51) Int. Cl. G08B 13/14

(52) U.S. Cl. 340/568.1

(57) ABSTRACT

A computer implemented method, apparatus, and computer usable program product for securing an electronic device is provided. The process withholds power to an electronic device in response to a failure to detect a presence of a trusted zone signal.

### BACKGROUND OF THE INVENTION

1. Field of the Invention:

The present invention relates generally to an improved data processing system, and in particular to a method and apparatus for securing an electronic device. More particularly, the present invention is directed to a computer implemented method, apparatus, and computer usable program product for securing an electronic device by implementing location awareness through power supplies.

2. Description of the Related Art:

Theft of electronic devices frequently occurs because the electronic devices are often portable, usually expensive and desirable, and typically unsecured. An electronic device is any device comprising components that utilize electricity provided by a power supply. For example, an electronic device can be a desktop computer, laptop computer, television, stereo system, computer monitor, or printer. In addition, the category of electronic devices may also include, for example, a hair dryer, microwave oven, refrigerator, blender, or any other similar devices.

One currently implemented solution for securing an electronic device and for deterring the theft of that device is locking the electronic device in an enclosure, such as a closet or a safe. This solution is impractical, however, especially for electronic devices that derive its benefit from remaining out in the open and available for use, such as a television.

Another currently used solution is affixing the electronic device to an immovable object. For example, to deter theft of televisions and other electronic devices from hotel rooms, the electronic devices are often bolted to the wall or a piece of furniture. This may be a viable solution to secure certain electronic devices, such as dishwashers, refrigerators, and other home appliances that generally remain in a fixed location. This solution, however, is impractical for certain types of electronic devices designed for portability, such as laptop computers or portable stereos. Similarly, affixing a security cable to the electronic device also eliminates portability. Moreover, security cables are unsightly and burdensome to implement, especially when affixed to portable electronic devices. For example, to move the portable electronic device secured with a security cable, the security cable must be unlocked and removed, then replaced and re-locked at a second location. In addition, this inconvenient solution can result in an unsightly tangle of security cables.

Another current solution for securing an electronic device is affixing a serial number or other form of identification to the electronic device, which can be traceable to the original owner. However, serial numbers and similar types of identification can be removed or otherwise destroyed. Even in the event that the serial numbers are not removable, the existence of serial numbers often does not affect the operability of the electronic device, and thus likely fails to deter theft.

The most failsafe solutions listed above are impractical, whereas the least intrusive solutions are often inadequate to prevent or deter theft of electronic device. For reasons such as these, current security measures for protecting electronic devices are often not implemented.

### SUMMARY OF THE INVENTION

The illustrative embodiments described herein provide a computer implemented method, apparatus, and computer usable program product for securing an electronic device. The process withholds power to an electronic device in response to a failure to detect a presence of a trusted zone signal.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network data processing system in which illustrative embodiments may be implemented;

FIG. 2 is a block diagram of a data processing system in which the illustrative embodiments may be implemented;

FIG. 3 is a block diagram of the data flow through components of a system for securing an electronic device in accordance with an illustrative embodiment;

FIG. 4 is a block diagram of the data flow through components of a system for securing an electronic device in accordance with another illustrative embodiment;

FIG. 5 is a flowchart of a process for supplying power to an electronic device in accordance with an illustrative embodiment; and

FIG. 6 is a flowchart of a process for supplying power to an electronic device in accordance with another illustrative embodiment.

### DETAILED DESCRIPTION OF THE PREFERRED EMBODIMENT

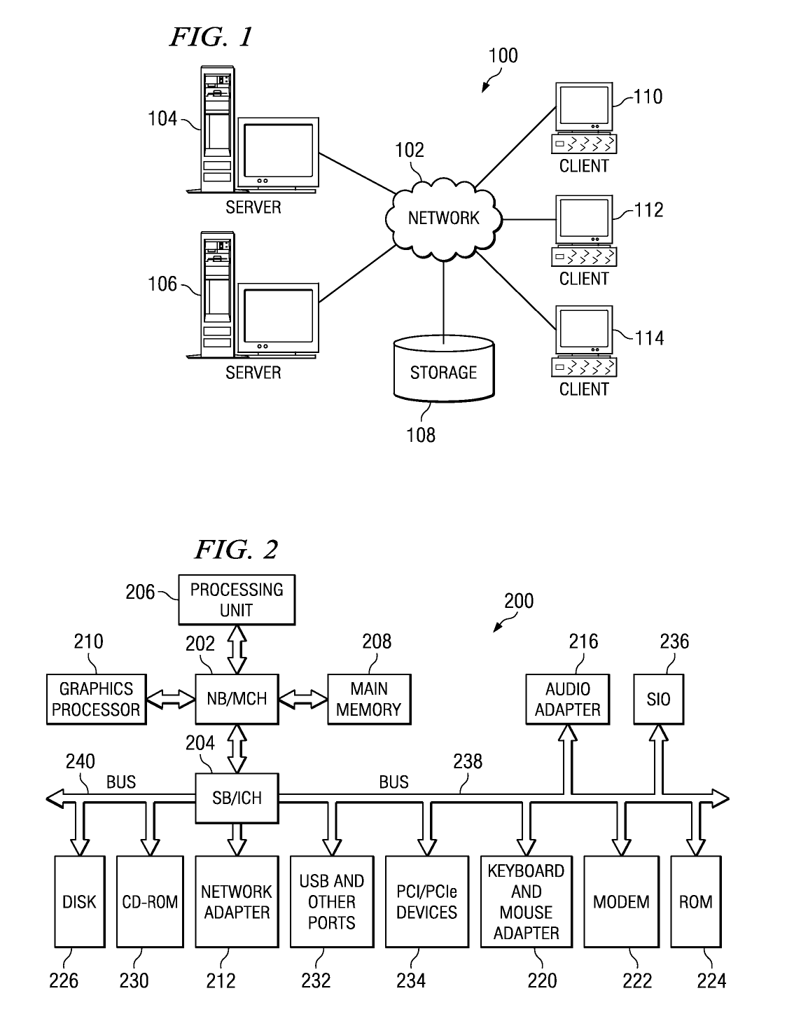

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

With reference now to the figures, FIG. 1 depicts a pictorial representation of a network of data processing system in which illustrative embodiments may be implemented. Network data processing system 100 is a network of computing devices in which embodiments may be implemented. Network data processing system 100 contains network 102, which is the medium used to provide communications links between various devices and computers connected together within network data processing system 100. Network 102 may include connections, such as wire, wireless communication links, or fiber optic cables. The depicted example in FIG. 1 is not meant to imply architectural limitations. For example, data processing system 100 also may be a network of telephone subscribers and users.

In the depicted example, server 104 and server 106 connect to network 102 along with storage unit 108. In addition, clients 110, 112, and 114 are coupled to network 102. Clients 110, 112, and 114 are examples of devices that may be utilized for transmitting and receiving signals used for securing electronic devices in a network, such as network 102. Clients 110, 112, and 114 may be, for example, a personal computer, laptop, tablet PC, or network computer, a radio, television, digital clock, hair dryer, washing machine, or any other electronic device. In the depicted example, server 104 provides data, such as boot files, operating system images, and applications to clients 110, 112, and 114. Clients 110, 112, and 114 are coupled to server 104 in this example. Network data processing system 100 may include additional servers, clients, electronic devices, and other computing devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), a wide area network (WAN), a telephone network, or a satellite network. FIG. 1 is intended as an example, and not as an architectural limitation for different embodiments.

With reference now to FIG. 2, a block diagram of a data processing system is shown in which illustrative embodiments may be implemented. Data processing system 200 is an example of a computing device, such as server 104 and clients 112 and 114 in FIG. 1, in which computer usable code or instructions implementing the processes may be located for the illustrative embodiments.

In the depicted example, data processing system 200 employs a hub architecture including a north bridge and memory controller hub (MCH) 202 and a south bridge and input/output (I/O) controller hub (ICH) 204. Processor 206, main memory 208, and graphics processor 210 are coupled to north bridge and memory controller hub 202. Graphics processor 210 may be coupled to the MCH through an accelerated graphics port (AGP), for example.

In the depicted example, local area network (LAN) adapter 212 is coupled to south bridge and I/O controller hub 204 and audio adapter 216, keyboard and mouse adapter 220, modem 222, read only memory (ROM) 224, universal serial bus (USB) ports and other communications ports 232, and PCI/PCIe devices 234 are coupled to south bridge and I/O controller hub 204 through bus 238, and hard disk drive (HDD) 226 and CD-ROM drive 230 are coupled to south bridge and I/O controller hub 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM drive 230 may use, for example, an integrated drive electronics (IDE) or serial advanced technology attachment (SATA) interface. A super I/O (SIO) device 236 may be coupled to south bridge and I/O controller hub 204.

An operating system runs on processor 206 and coordinates and provides control of various components within data processing system 200 in FIG. 2. The operating system may be a commercially available operating system such as Microsoft® Windows® XP. Microsoft and Windows are trademarks of Microsoft Corporation in the United States, other countries, or both. The operating system may also be a retail specific operating system, such as IBM® 4690 Operating System®. An object oriented programming system, such as the Java™ programming system, may run in conjunction with the operating system and provides calls to the operating system from Java programs or applications executing on data processing system 200. Java and all Java-based trademarks are trademarks of Sun Microsystems, Inc. in the United States, other countries, or both.

Instructions for the operating system, the object-oriented programming system, and applications or programs are located on storage devices, such as hard disk drive 226, and may be loaded into main memory 208 for execution by processor 206. The processes of the illustrative embodiments may be performed by processor 206 using computer implemented instructions, which may be located in a memory such as, for example, main memory 208, read only memory 224, or in one or more peripheral devices.

In some illustrative examples, data processing system 200 may be a personal digital assistant (PDA), which is generally configured with flash memory to provide non-volatile memory for storing operating system files and/or user-generated data. A bus system may be comprised of one or more buses, such as a system bus, an I/O bus and a PCI bus. Of course the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 208 or a cache such as found in north bridge and memory controller hub 202. A processing unit may include one or more processors or CPUs. The depicted examples in FIGS. 1-2 and above-described examples are not meant to imply architectural limitations. For example, data processing system 200 also may be a tablet computer, laptop computer, or telephone device in addition to taking the form of a PDA.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system.

The illustrative embodiments described herein provide a computer implemented method, apparatus, and computer usable program product for securing an electronic device. The process, in these illustrative examples, withholds power to an electronic device in response to a failure to detect a presence of a trusted zone signal.

The configuration mentioned above is a user defined policy comprising a set of rules that governs the supply of power to the electronic device by an intelligent power supply. The configuration can include, for example, a policy for instructing the intelligent power supply when and how to send or receive a signal used for forming a trusted zone signal. The configuration may also include, for example, identifiers for identifying the electronic device and a signal generator. In addition, the configuration may include a password to enable subsequent access and modification of the configuration, and an encrypted key for accessing and communicating with the signal generator.

An intelligent power supply is a power supply coupled to a logic controller. The power supply is a device, component of a device, or system that supplies electricity or other types of energy to an electronic device. The logic controller may be a software component, hardware component, or a combination of hardware and software for instructing, according to the configuration, the power supply to supply or withhold power to the electronic device.

The logic controller may be integrated within the power supply, or integrated within a component of the electronic device located planar to the power supply. A component located planar to the power supply is any component within an electronic device capable of supporting the hardware and/or software comprising the logic controller. For example, where the electronic device is a desktop computer, a component planar to the power supply within the desktop computer may be the motherboard. By interfacing the logic controller with the power supply from a component planar to the power supply, replacement of the power supply would not circumvent the security features of the intelligent power supply.

A trusted zone signal is formed when a signal generated by a signal generator is associated with a configuration received by the intelligent power supply. A signal is an event, message, or data structure transmitted between computational processes or computing devices. A signal may be transmitted via any type of wired or wireless transmission medium, such as, for example, copper wire, fiber optic, laser, radio wave, infra-red light or Bluetooth®.

A trusted zone signal is a signal receivable by an electronic device, or by a component within an electronic device, such as an intelligent power supply. Receipt or the detection of the presence of the trusted zone signal by an electronic device, or by a component within the electronic device, indicates that the electronic device is within a trusted zone.

The trusted zone is the location or locations where a trusted zone signal may be received by an electronic device. In one embodiment, the trusted zone signal is generated by a signal generator. A signal generator is any device capable of sending and receiving signals, such as a wireless router, a modem, a computer, a central alarm system, a personal digital assistant (PDA), or any other computing device capable of generating a signal. For instance, in the example where the signal generator is a wireless router located within a residence, and the electronic device is a desktop computer, the trusted zone may comprise the various locations throughout the residence from which the desktop computer is capable of detecting and receiving the router signal. When the security features of the intelligent power supply are enabled, the electronic device only operates within the trusted zone.

In an illustrative embodiment, the electronic device receives a signal from a router, a computer, or other signal generator via a wired or wireless network. In another illustrative embodiment, the electronic device receives the signal via a power supply coupled to a power outlet connected to an electrical system configured to support an Ethernet over power lines network. An Ethernet over power lines network is a network of computing devices coupled together through the power lines of a building or residence. The Ethernet over power lines network is created by coupling an Ethernet over power lines adapter to a modem, or similar device, and also to an electrical outlet connected to the power lines within the building or residence.

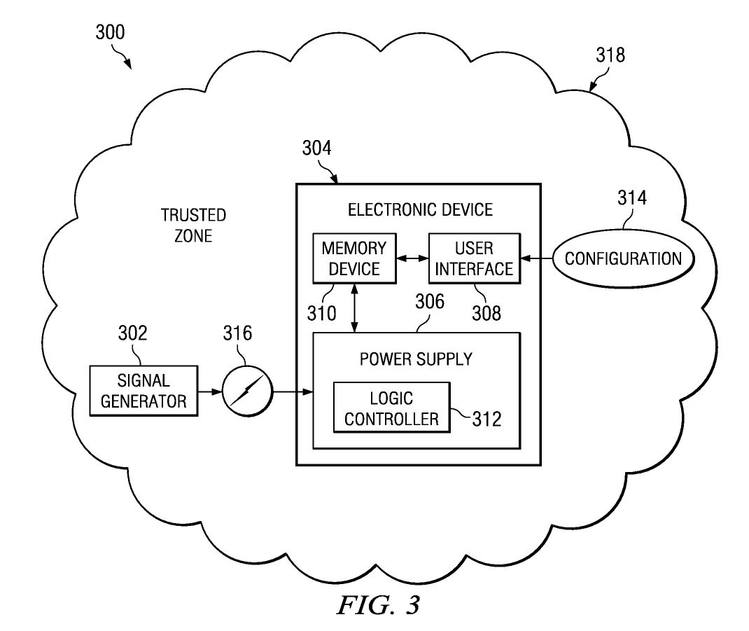

Turning now to FIG. 3, a block diagram of data flow through components of a system for securing an electronic device is shown in accordance with an illustrative embodiment. In this illustrative embodiment of FIG. 3, network data processing system 300 is a network data processing system, such as network data processing system 100 of FIG. 1.

Network data processing system 300 is comprised of signal generator 302 and electronic device 304. Electronic device 304 is further comprised of power supply 306, user interface 308, and memory device 310. In this embodiment depicted in FIG. 3, user interface 308 is coupled to memory device 310, which is in turn coupled to power supply 306. In addition, power supply 306 further comprises logic controller 312. Memory 310 can be any type of memory, such as, for example, flash memory, equivalent non-volatile memory, or optical disk drives.

Logic controller 312 may be a software component, hardware component, or a combination of hardware and software for determining, according to the configuration, whether or not power supply 306 is permitted to supply power to electronic device 304. Although logic controller 312 is depicted as a component within power supply 306, in another embodiment, logic controller 312 may be a device separate from, but coupled to power supply 306. Logic controller 312 may be integrated into components planar to power supply 306.

In this illustrative embodiment, user interface 308 is operable to utilize electronic device 304 and to generate a configuration at a menu interface presented to a user. User interface 308 is any known or available type of user interface, including but not limited to, a touch screen, a graphical user interface (GUI), a keyboard, a mouse, an alphanumeric keypad, a voice recognition system, or any other type of user interface. Although user interface 308 is depicted as a component of electronic device 304, in another embodiment user interface 308 may be a component separate from electronic device 304. For example, where electronic device 304 is a television, user interface 308 comprises the television screen, the remote control, and other I/O components and devices associated with operating the television.

In addition, user interface 308 may be a component of a separate computing device operable to utilize electronic device 304. For example, electronic device 304 may be a TiVo® digital video recorder (DVR), and user interface 308 may be the user interface of a television coupled to the TiVo® digital video recorder which is operable to utilize the TiVo® digital video recorder.

Either before or after electronic device 304 is introduced to a new location having an existing network, a user (not shown) interacts with user interface 308 in order to generate configuration 314. Configuration 314, which is associated with a signal in order to form a trusted zone signal, can comprise information including, for example, an identifier identifying electronic device 304, such as a unique serial number or name, and an identifier of signal generator 302, such as a media access control (MAC) address for the embodiment where signal generator 302 is a wireless router. In addition, configuration 314 may include, for example, a password for accessing or modifying configuration 314 at a later date, and a password or encrypted key for accessing or communicating with signal generator 302. Configuration 314 may also include any other information that may be useful or necessary in order to establish a trusted zone signal.

The password for accessing configuration 314 at a later date may be used by an authorized user of electronic device 304 to disable the security features of electronic device 304. The authorized user may desire to disable the security features of electronic device 304 if the authorized user attempts to use electronic device 304 in a location outside of trusted zone 318.

In this illustrative example, the un-depicted user generates configuration 314 at user interface 308. The user may generate configuration 314 by interacting with a menu interface provided by electronic device 304 via user interface 308. The menu interface is a visual or auditory interface coupled with input/output components, and which serve as a point of interaction between a user and an electronic device for purposes of generating a configuration. The menu interface may prompt the user of electronic device 304 to input the information required for generating configuration 314. The information and data contained within configuration 314 may be stored in memory device 310.

In this illustrative embodiment, once electronic device 304 is powered up in a location having a detectable network, power supply 306 receives signal 316 from signal generator 302. Signal 316 may contain information such as an identifier to identify electronic device 304, an identifier to identify signal generator 302, and one or more passwords or encrypted keys to enable electronic device 304 to communicate with signal generator 302. In this illustrative embodiment, logic controller 312 associates configuration 314 with signal 316 by comparing the information embodied within signal 316 with the information of configuration 314 stored in memory device 310. If the information of signal 316 and configuration 314 match, then logic controller 312 forms a trusted zone signal. Thereafter, logic controller 312 transmits the trusted zone signal to power supply 306, which serves to instruct power supply 306 to provide power to electronic device 304.

For instance, in the illustrative embodiment where signal generator 302 is a modem coupled to a device for converting the power lines of a house into an Ethernet over power lines network, and electronic device 304 is a television, trusted zone 318 may include all the rooms in the residence having an electrical outlet. Plugging power supply 306 into any electrical outlet allows electronic device 304 to receive signal 316 generated by signal generator 302, which, in this example, is the modem.

In another illustrative embodiment, where electronic device 304 is a battery-operated stereo or a laptop computer running on batteries, signal 316 is receivable via a wired or wireless connection, such as an Ethernet cable or a wireless signal generated by a wireless router. For example, where electronic device 304 is the battery-operated laptop computer, a network adapter (not shown) is operable to receive signal 316. When configuration 314 is associated with signal 316, a trusted zone signal is formed, allowing the laptop to operate within trusted zone 318. The network adapter can be, for example, a modem, a wireless network card, an Ethernet card, or any device capable of allowing electronic device 304 to interact with other computing devices or data processing systems through intervening private or public networks.

In the illustrative embodiment described above, a user generates configuration 314 at user interface 308 of electronic device 304. For example, if electronic device 304 is a television, a menu interface operable for generating configuration 314 may comprise visual information displayed on the television screen. The screen may be navigable and programmable by supplying prompted information using the television's remote control. In another embodiment, where electronic device 304 is a telephone, the menu interface may comprise a series of auditory prompts navigable by pressing the buttons of the phone.

In addition, configuration 314 may be generated at a menu interface presented to a user operating signal generator 302 or a remote computing device (not shown). A remote computing device can be, for example, a computer on the same network as the electronic device, or in a separate network as electronic device 304, but communicatively coupled to the electronic device. After configuration 314 is generated at either signal generator 302 or at the remote computing device, configuration 314 is transmitted to electronic device 304 for storage in memory device 310 until configuration 314 is necessary for forming a trusted zone signal.

In another embodiment, configuration 314 may be generated by a third party at a remote computing device and later transmitted to electronic device via a communications component (not shown). The communications component may be, for example, a network adapter, such as a modem, a wireless network card, an Ethernet card, or any device capable of allowing electronic device 304 to interact with other computing devices or data processing systems through intervening private or public networks.

Configuration 314 generated by the third party is stored within memory device 310. The third party may be, for example, a manufacturer or vendor of electronic device 304, or a security company which may be employed by a user of electronic device 304. In this embodiment, either before or after purchase of electronic device 304, the user may communicate certain information to the third party for purposes of generating configuration 314. As described above, the communicated information can include, for example, an identifier identifying electronic device 304, an identifier of signal generator 302, a password for accessing configuration 314, and an encrypted key for accessing or communicating with signal generator 302.

For example, a user of a newly purchased laptop computer may communicate to the laptop vendor the specific model and serial number of the laptop and the media access control (MAC) address of wireless router, or an encrypted key, such as a wired equivalent privacy (WEP) key of a wireless router. In addition, the user may specify a password that the laptop vendor can incorporate into the configuration to enable an authorized user of the laptop to access or modify the configuration at a later date, if, for example, the user desired to operate the device outside of the trusted zone. In this manner, the user could disable the security feature that prevents the electronic device from powering up, but an unauthorized user or thief would be unable to bypass the security features offered by the intelligent power supply.

In another illustrative embodiment, electronic device 304 may be purchased or otherwise obtained by a user with information for use in generating configuration 314 already stored in memory device 310. In addition, electronic device 304 may comprise hardware and/or software for automatically generating configuration 314 once electronic device 304 is powered up for the first time in the presence of signal 316. Subsequently, in this embodiment, electronic device 304 may prompt the user to input a password to enable the user to access or modify configuration 314 at a later date.

Configuration 314 may specify a monitoring policy indicating the times at which power supply 306 and logic controller 312 seek to receive signal 316. In addition, the monitoring policy of configuration 314 may specify certain events triggering monitoring power supply 306 and logic controller 312 to seek signal 316. The monitoring policy may be specified by a user during the generation of configuration 314, or the monitoring policy may be preprogrammed into electronic device 304 and stored within memory device 310.

For example, a monitoring policy may instruct power supply 306 and logic controller 312 to continually monitor for signal 316 while electronic device 304 is in standby. Standby is a state of an electronic device when the device is receiving power but is not being actively used, such as when a television is plugged into an electrical outlet, but the television is “off.” The monitoring policy may also instruct power supply 306 and logic controller 312 to periodically monitor for signal 316 at certain predetermined times of the day. If signal 316, or the trusted zone signal formed from signal 316 is not detected by power supply 306 for a predetermined amount of time, then logic controller 312 instructs power supply 306 to withhold power to electronic device 304. Thus, the periodic monitoring for signal 316 by a battery operated laptop in standby, for example, will not cause the laptop to consume excess battery power to continually monitor for signal 316.

In another embodiment, logic controller 312 may instruct power supply 306 to withhold power to electronic device 304 after the occurrence, or non-occurrence of a specified event. For instance, logic controller 312 may instruct power supply 306 to withhold power to electronic device 304 if electronic device 304 is powered up outside of trusted zone 318 in excess of a predetermined number of times. A user may supply this predetermined number during the generation of configuration 314.

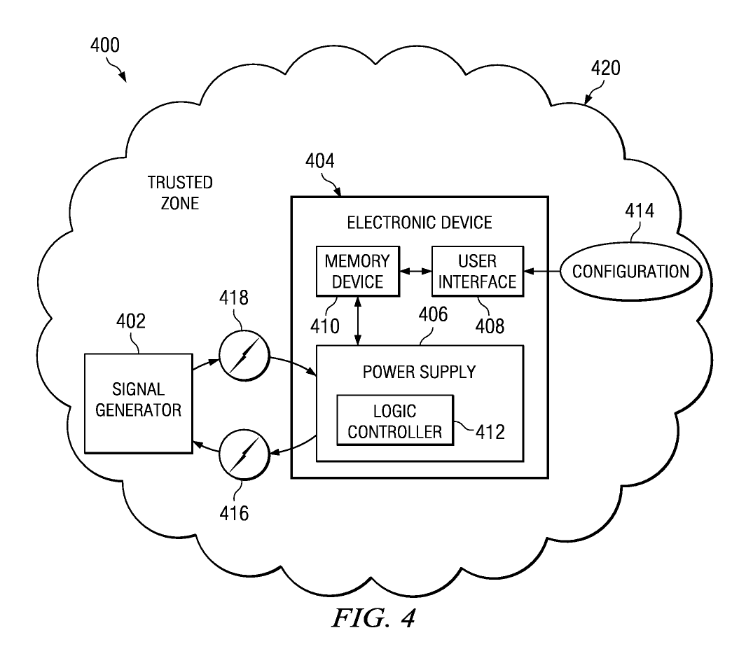

Turning now to FIG. 4, a block diagram of data flow through components of a system for securing an electronic device is shown in accordance with another illustrative embodiment. In this illustrative embodiment of FIG. 4, network data processing system 400 is a network data processing system, such as network data processing system 100 of FIG. 1.

Network data processing system 400 is comprised of signal generator 402 and electronic device 404. Signal generator 402 can be any signal generator, such as signal generator 302 of FIG. 3. Likewise, electronic device 404 can be any electronic device, such as electronic device 304 of FIG. 3. Electronic device 404 is further comprised of power supply 406, user interface 408, and memory device 410. In this embodiment as depicted in FIG. 4, user interface 408 is coupled to memory device 410, which is in turn coupled to power supply 406. In addition, power supply 406 further comprises logic controller 412. User interface 408 and memory device 410 function in the same manner as user interface 308 of FIG. 3, and memory device 310 of FIG. 3, respectively.

For example, either before or after electronic device 404 is introduced to a new location having an existing network, a user (not shown) interacts with user interface 408 in order to generate configuration 414. Configuration 414 may be generated to include the same information, and in the same manner as described above with respect to the generation of configuration 314 of FIG. 3. Furthermore, configuration 414 may also be stored within memory device 410.

In this illustrative embodiment, once electronic device 404 is powered up in a location having an existing network, logic controller 412 instructs power supply 406 to transmit signal 416 for receipt by signal generator 402. In this embodiment, signal 416 includes the information contained within configuration 414. Upon receipt of signal 416, signal generator 402 may associate signal 416 and configuration 414 by, for example, confirming that electronic device 404 is in fact the source of signal 416, and that the information contained within configuration 414 corresponds with similar information stored within signal generator 402, such as the media access control (MAC) address or WEP key of signal generator 402.

After associating configuration 414 with signal 416, signal generator 402 forms trusted zone signal 420, which is transmitted back to power supply 406. Receipt or detection of the presence of trusted zone signal 420 by power supply 406 indicates that electronic device 404 is within trusted zone 420. Consequently, logic controller 412 enables power supply 406 to supply power to electronic device 404 while electronic device is within trusted zone 420.

For instance, in the illustrative embodiment where signal generator 402 is a modem coupled to a device for converting the power lines of a house into an Ethernet over power lines network, electronic device 404 is a television, and trusted zone 420 may include all those rooms in the residence having an electrical outlet. Plugging power supply 406 into any electrical outlet allows electronic device 404 to send signal 416 to the modem via the Ethernet over power lines network. Signal 416 contains the information previously generated in configuration 414, such as, for example, the media access control (MAC) address of the modem, and password for accessing or modifying configuration 414, and an encrypted key of the modem, which is similar to a wireless encryption password (WEP) key of a wireless router, and an identifier identifying the electronic device 404. Upon receiving signal 416, signal generator associates the information of configuration 414 with signal 416 and returns to electronic device 404 and trusted zone signal 418 via power supply 406. Power supply 406 provides power to electronic device 404.

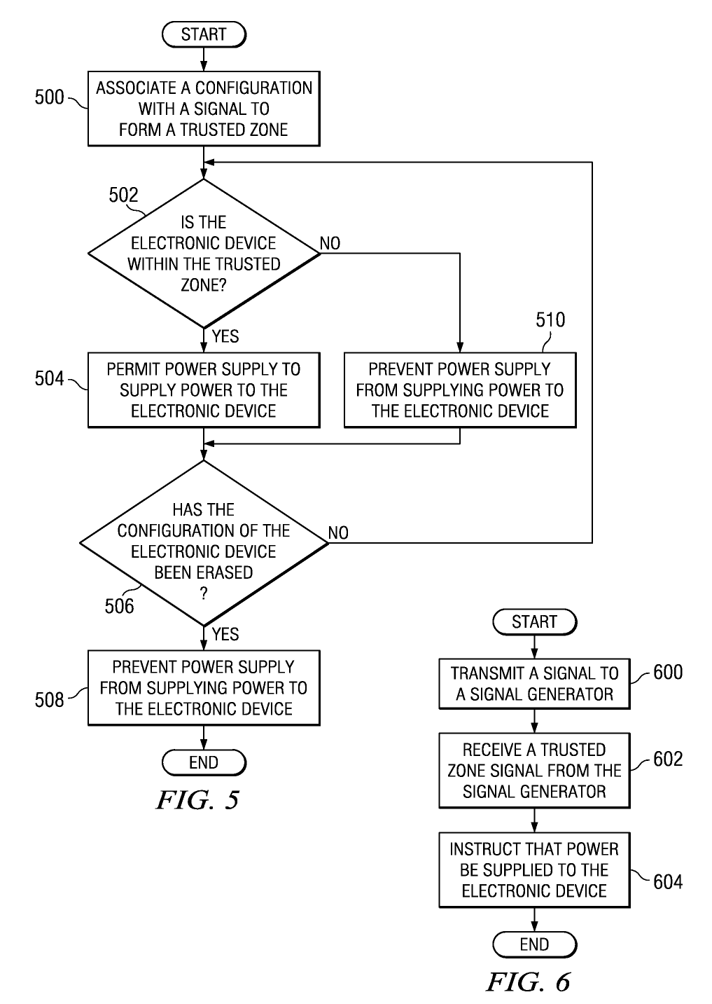

Turning now to FIG. 5, a flowchart of a process for providing power to an electronic device is depicted in accordance with an illustrative embodiment. The process may be performed by logic controller 312 of FIG. 3.

The process begins by associating a configuration with a signal to form a trusted zone (step 500). The process then makes the determination as to whether the electronic device is within the trusted zone (step 502). If the process makes the determination that the electronic device is within the trusted zone (yes output to step 502), then the process permits a power supply to supply power to the electronic device (step 504).

The process then makes the determination as to whether the configuration of the electronic device has been erased (step 506). If the configuration of the electronic device has not been erased (no output to step 506), then the process returns to step 502. Otherwise, if the process makes the determination that the configuration of the electronic device has been erased (yes output to step 506), then the process prevents the power supply from supplying power to the electronic device (step 508), and the process terminates thereafter.

Returning now to step 502, if the process makes the determination that the electronic device is not within the trusted zone (no output to step 502), then the process prevents the power supply from supplying power to the electronic device (step 510), and the process proceeds to step 506.

Turning now to FIG. 6, a flowchart of a process for providing power to an electronic device is depicted in accordance with another illustrative embodiment. The process may be performed by logic controller 312 of FIG. 3.

The process begins by transmitting a signal to a signal generator (step 600). The signal may include information contained within a configuration, such as configuration 314 of FIG. 3. The process then receives a trusted zone signal from the signal generator (step 602). The process then instructs that power be supplied to the electronic device (step 604).

The illustrative embodiments described herein provide a computer implemented method, apparatus, and computer usable program product for securing an electronic device. The process withholds power to an electronic device in response to a failure to detect a presence of a trusted zone signal.

Using this computer implemented method, apparatus, and computer program product, security features can be seamlessly integrated into electronic devices for purposes of deterring theft of the electronic devices. Furthermore, theft of all electronic devices may be deterred if a location, such as a residence, advertises that the presence of electronic devices secured in the manner disclosed above. A common thief would be unable to distinguish which electronic devices are secured.

In addition, a user of electronic devices may employ a home security company to monitor the user's electronic devices. The home security company's central alarm system that is already present at the user's residence can be integrated into the trusted zone by coupling it to the Ethernet over power lines network, for example. The central alarm system could then serve as the signal generator. The security company could then monitor the electronic devices and notify the user of instances of theft.

The flowchart and block diagrams in the figures illustrate the architecture, functionality, and operation of some possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially, concurrently, or the blocks may sometimes be executed in the reverse order, depending upon the functionality involved.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices, including but not limited to keyboards, displays, and pointing devices, can be coupled to the system either directly or through intervening I/O controllers.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for securing an electronic device, the computer implemented method comprising:
responsive to a failure to detect a presence of a trusted zone signal, withholding power to the electronic device.

2. The computer implemented method of claim 1, further comprising:
generating a signal by the electronic device; and
responsive to generating the signal, transmitting the signal from the electronic device to a signal generator, wherein the signal generator associates the signal with a configuration to form the trusted zone signal and returns the trusted zone signal to the electronic device.

3. The computer implemented method of claim 1, further comprising:
receiving a signal at the electronic device from a signal generator, wherein the electronic device associates the signal with a configuration to form the trusted zone signal.

4. The computer implemented method of claim 1 further comprising:
generating a configuration at a menu interface presented at one of the electronic device, a signal generator, and a remote computing device, wherein a signal is associated with the configuration to form the trusted zone signal.

5. The computer implemented method of claim 1 further comprising:
responsive to receiving a signal, associating the signal with a configuration to form the trusted zone signal; and
responsive to the electronic device detecting the presence of the trusted zone signal, supplying the power to the electronic device, wherein the presence of the trusted zone signal indicates that the electronic device is within a trusted zone.

6. The computer implemented method of claim 5, wherein the signal comprises a data structure, and wherein the data structure further comprises one of a password or an encrypted key.

7. The computer implemented method of claim 5, wherein the trusted zone is a home network.

8. The computer implemented method of claim 7, wherein the home network is an Ethernet over power lines network.

9. The computer implemented method of claim 1, wherein detecting the presence of the trusted zone signal further comprises:
receiving the trusted zone signal through an intelligent power supply coupled to an Ethernet over power lines network.

10. A computer usable program product comprising:
a computer usable medium including computer usable program code for securing an electronic device, the computer usable program product comprising:
computer usable program code for withholding power to the electronic device responsive to a failure to detect a presence of a trusted zone signal.

11. The computer usable program product of claim 10 further comprising:
computer usable program code for generating a signal by the electronic device; and
computer usable program code for transmitting the signal from the electronic device to a signal generator responsive to generating the signal, wherein the signal generator associates the signal with a configuration to form the trusted zone signal and returns the trusted zone signal to the electronic device.

12. The computer usable program product of claim 10 further comprising:
computer usable program code for receiving a signal at the electronic device from a signal generator, wherein the electronic device associates the signal with a configuration to form the trusted zone signal.

13. The computer usable program product of claim 10 further comprising:
computer usable program code for presenting a menu interface for generating a configuration, wherein the menu interface is presented at one of the electronic device, a signal generator, and a remote computing device, and wherein a signal is associated with the configuration to form the trusted zone signal.

14. The computer usable program product of claim 10 further comprising:
computer usable program code for associating a signal with a configuration responsive to receiving the signal, wherein associating the signal with the configuration forms the trusted zone signal; and
computer usable program code for supplying the power to the electronic device responsive to the electronic device detecting the presence of the trusted zone signal, wherein the presence of the trusted zone signal indicates that the electronic device is within the trusted zone.

15. The computer usable program product of claim 14, wherein the computer usable program code further comprises:
computer usable program code for generating the signal, wherein the signal comprises a data structure, and wherein the data structure further comprises one of a password and an encrypted key.

16. An apparatus comprising:
a logic controller for controlling a supply of power to the apparatus; and
a power supply coupled to the logic controller, wherein the power supply is operable to supply power to the apparatus.

17. The apparatus of claim 16, wherein the logic controller is integrated with at least one of the power supply and a component planar to the power supply.

18. A system for securing an electronic device, the system comprising:
a signal generator, wherein the signal generator generates a signal for receipt by an electronic device; and
the electronic device, wherein the electronic device comprises a power supply for supplying power to the electronic device responsive to detecting a presence of a trusted zone signal, and wherein the presence of the trusted zone signal indicates that the electronic device is within a trusted zone.

19. The system of claim 18, wherein the trusted zone is an Ethernet over power lines network.

20. The system of claim 18, wherein the signal generated by the signal generator is the trusted zone signal.
